(19) United States
(12) Patent Application Publication
(10) Pub. No.: US 2007/0119549 A1
(43) Pub. Date: May 31, 2007

(54) Sliding panel interlock

(76) Inventor: William R. Weiland, Rancho Santa Fe, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/290,161

(22) Filed: Nov. 30, 2005

(51) Int. Cl. E06B 3/12

(52) U.S. Cl. 160/226

(57) ABSTRACT

Embodiments of the present invention provide for shock absorbing interlocks for multi-panel sliding doors that operate smoothly and relatively noiselessly. Some embodiments combine external and internal shock absorbers, with friction bearing contacts. An optional motion dampening component can additionally absorb shock.

### TECHNICAL FIELD

This invention relates to sliding panel assemblies, and in particular to interlocks for multi-panel sliding doors.

### BACKGROUND ART

Sliding panel doors are popular for applications where a large doorway must be closed. But when such a door is open, the panels should unobtrusively occupy a minimum volume of space. Applications range from closet doors to room dividers for banquet halls. A plurality of panels can be used, depending on the desired sliding panel size and the size of the entryway. During opening and closing, a lead panel is typically moved along a track. As force is applied to the lead panel, it engages a second panel to be drawn along in the direction of the force applied to the lead panel. The lead panel engages and “catches” the second panel by means of corresponding interlocks that engage each other when the lead panel moves toward or away from the second panel. The second panel can then, in turn engage a third panel, through another interlock, and so on. In this manner, by moving the lead panel, all of the panels in a door assembly can be deployed.

In particular, it is desirable that when opening or closing such a multi-panel door, that the action be smooth and relatively silent. Conventional sliding panel interlocks can be noisy and jarring when they engage. Additionally, when the weight of the panels is relatively heavy, the interlocks and/or panels themselves can be damaged during the opening or closing of the panels.

### SUMMARY OF THE INVENTION

Embodiments of the present invention provide for shock absorbing interlocks for multi-panel sliding doors that operate smoothly and relatively noiselessly. In one embodiment, the interlock includes an internal shock absorber, and an external contact shock absorber, with friction bearing contacts. An optional motion dampening component can additionally absorb shock.

### BRIEF DESCRIPTION OF THE DRAWINGS

FIG. 1a illustrates the closing of a three panel sliding door according to an embodiment of the invention.

FIG. 1b illustrates the three panel sliding door of FIG. 1A in a closed position.

FIG. 2 illustrates the interlocking of a pair of adjacent sliding panels according to an embodiment of the invention.

FIG. 3a illustrates an embodiment of the invention using a helical spring shock absorber, prior to interlocking.

FIG. 3b illustrates the embodiment of FIG. 3a when interlocked.

FIGS. 4a through 4c illustrate embodiments with alternative shock absorbing elements. FIG. 4a uses a helical spring shock absorber. FIG. 4b uses a foam insert shock absorber. FIG. 4c uses an elastomeric shock absorber.

FIG. 5 illustrates a cross-sectional view of a housing member according to an embodiment of the invention.

FIG. 6 illustrates a cross-sectional view of a sliding insert member according to an embodiment of the invention.

FIG. 7 illustrates a cross-sectional view of a housing member assembled with a sliding insert member according to an embodiment of the invention.

FIG. 8 illustrates a cross-sectional view of an embodiment of the invention with additional components.

FIG. 9 illustrates an exploded, perspective view of the embodiment of FIG. 8.

FIG. 10a illustrates a side, cross-sectional view of another embodiment of the invention, using a leaf spring shock absorber.

FIG. 10b illustrates a top, interior view of the embodiment of FIG. 10a.

FIG. 11a illustrates a side, cross-sectional view of the embodiment of FIG. 10, showing additional components.

FIG. 11b illustrates a top, interior view of the embodiment of FIG. 11a.

FIG. 12 illustrates a side, cross-sectional view of the embodiment of FIGS. 11a and 11b, installed on a pair of adjacent sliding panels.

Commonly numbered drawing elements in the various figures refer to common elements of the embodiments of the invention. The drawings of the embodiments shown in the figures are not necessarily to scale. The drawings of the embodiments shown in the figures are for purposes of illustration only, and should not be construed to limit the scope of the invention.

### DETAILED DESCRIPTION OF THE INVENTION

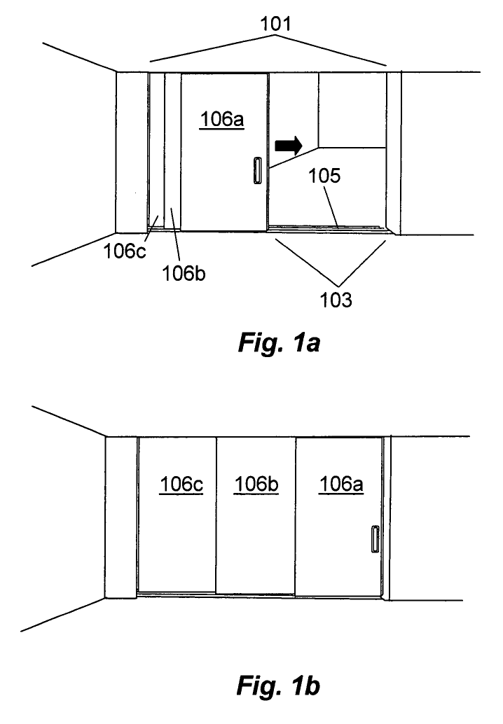

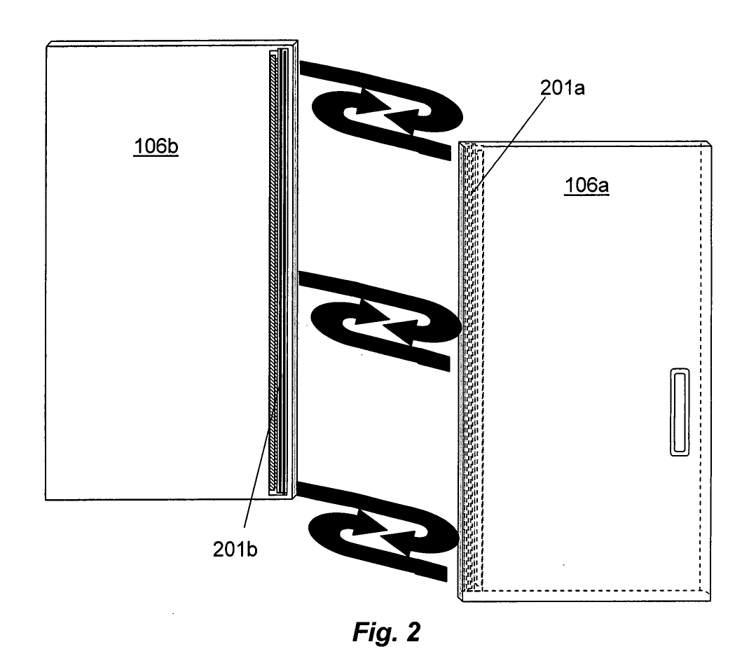

FIGS. 2a and 1B illustrate the operation of a three panel sliding door. Individual panels 106a, 106b, and 106c travel on a set of tracks 103 to open and close. The travel can be facilitated by slides, rollers, or other types of bearings. An additional set of tracks or channels is usually provided for the tops of the panels, to maintain them in vertical positions, however this is not shown. FIG. 1a illustrates the open position of the door, and FIG. 1b illustrates the closed position. In some embodiments, the panels can slide entirely into a wall, opening up the entire entryway 101.

In preferred embodiments it is only necessary to apply force to sliding panel 106a, because sliding panel 106a mechanically interlocks with adjacent sliding panel 106b, which in turn can mechanically interlock with panel 106c, drawing all of the panels across the opening 103, in this three panel example. Although FIGS. 1a and 1b illustrate a three panel sliding door, in general there may be more or fewer than three panels, depending on the desired panel size, and the size of the entryway 101 to be closed.

FIG. 2 illustrates a configuration of interlock assemblies on adjacent sliding panels according to one embodiment of the invention. Interlock assemblies 201a and 201b on sliding panels 106a and 106b, respectively engage as indicated by the bold arrows. In some embodiments, interlock assemblies 201a and 201b can be of substantially identical design. Although as illustrated in FIG. 2, interlock assemblies 201a and 201b extend substantially the vertical lengths of their respective sliding panels, alternatively they may extend only partially over the vertical lengths in one or more segments configured to interlock the sliding panels.

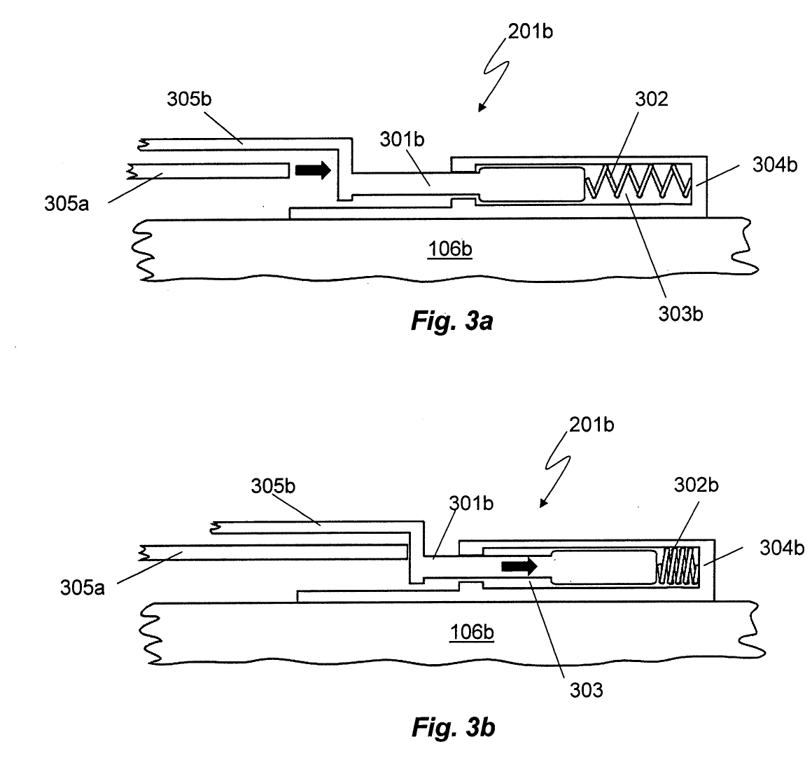

In order to illustrate a high level operation of one embodiment of the invention, FIGS. 3a and 3b show cross-sectional views of pre-interlocked, and interlocked states, respectively, of an interlock assembly mounted on a sliding panel 106b (when viewed upwardly from the bottom of sliding panel 106b toward the top of sliding panel 106b). Sliding insert member 301b is assembled with interlock housing member 304b, which includes an internal channel 303b for slidably holding a portion of the sliding insert member 301b therein. In one embodiment, the sliding insert member 301b and the interlock housing member 304b extend substantially along the entire length of housing 304 (normal to the plane of the illustration). The sliding insert member 301b includes an engagement lip 305b, that catches and engages with a corresponding engagement lip 305a of interlock 201a (shown in FIG. 2). An internal shock absorber comprising spring 302b absorbs shock as interlock assembly 201a, mounted to sliding panel 106a, engages interlock assembly 201b mounted to panel 106b as shown in FIG. 3b. In one embodiment, interlocks 201a and 201b are structures having a common design.

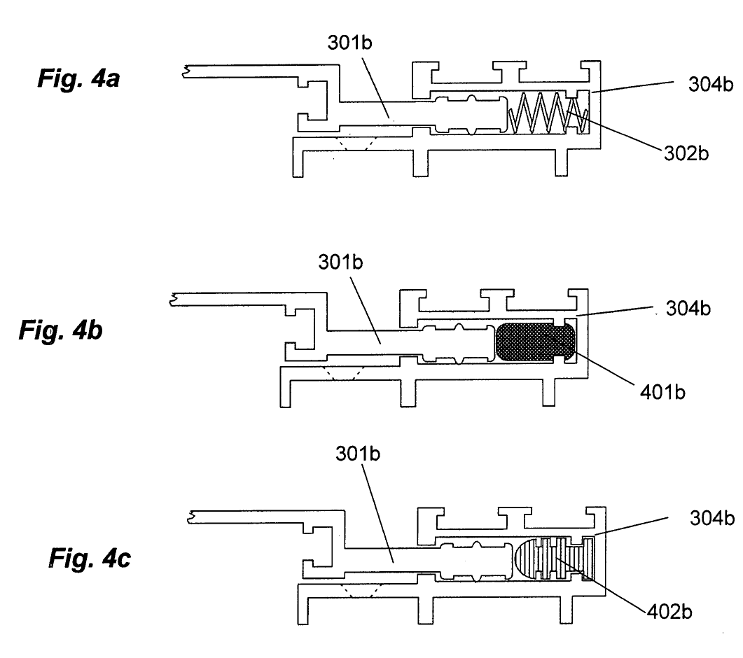

FIGS. 4a, 4b, and 4c illustrate different internal shock absorbing options according to different embodiments of the invention. FIG. 4a shows a helical spring 302b as in FIGS. 3a and 3b. FIG. 4b shows a resilient polymer foam shock absorber 401b. The foam may be of open or closed cell type, comprising a resilient polymer such as polyurethane or latex. Shock absorber 401b can extend substantially the length of interlock housing member (normal to the plane of the illustration). FIG. 4c illustrates the use of an elastomeric shock absorber 402b. In one embodiment, the elastomer can be configured with corrugated sections to enhance the extent of reversible deformation during shock absorption. The elastomer material can be polyurethane, latex, or the like.

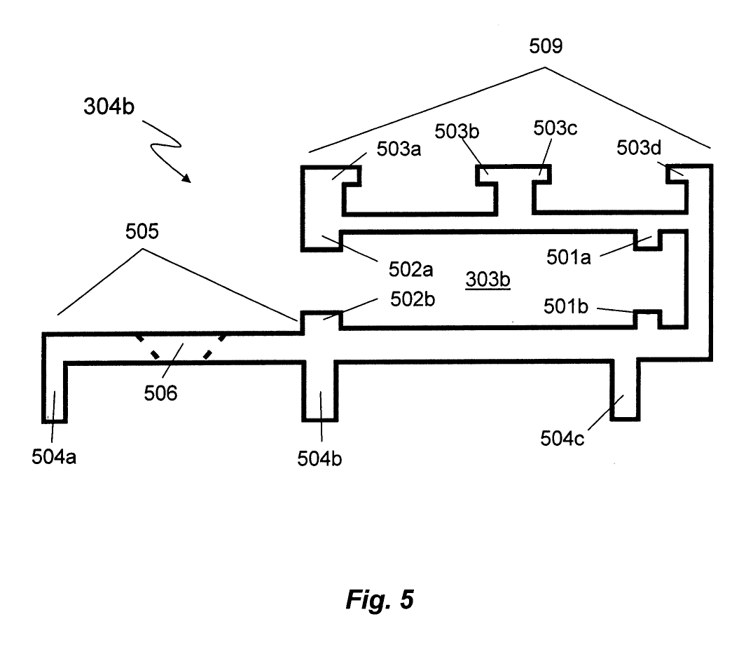

FIG. 5 illustrates a detailed cross-sectional view of an interlock housing member according to one embodiment of the invention. Top surface 509 is configured with holding ridges 503a, 503b, 503c, and 503d configured to hold two substantially parallel friction bearing, and/or shock absorbing gaskets (not shown) for contact with an adjacent sliding panel. Although as illustrated, there are provisions for two such gaskets, there could alternatively be one gasket, more than two gaskets, or no gaskets. Ridges 502a and 502b are configured to hold a sliding insert member in place, whereas ridges 501a and 501b are configured to hold an internal shock absorber in place. Pedestals 504a, 504b, and 504c are configured to lift the interlock body member 304b slightly away from a panel to which it is mounted. Gaskets (not shown) may be placed between pedestals 504a, 504b, and 504c prior to fastening the base 505 to a sliding panel. Extended base 505, has screw holes 506 formed therein periodically along the dimension normal to the illustration for mounting the interlock housing member to a sliding panel.

The interlock housing member 304b of FIG. 5 can be extruded, normal to the plane of the illustration, and cut to a desired length. The material can be a metal or alloy such as aluminum or brass, or a polymer such as ABS, or a composite material. Alternatively, interlock housing member 304 can be machined and/or molded through a variety of techniques that are well known to one of ordinary skill in the art. Note that in some embodiments the interlock assemblies are “gender less,” meaning that only one type of interlock assembly is necessary, the one type of interlock assembly being able to mate with other interlock assemblies of the same type.

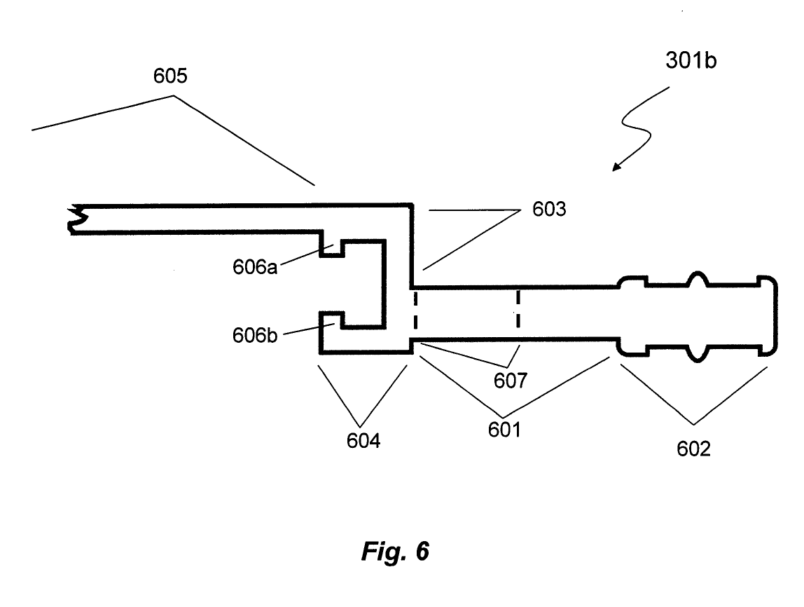

FIG. 6 illustrates a cross-sectional view of sliding insert member 301b according to an embodiment of the invention. Engagement lip 605 is coupled through sections 603 and 601 to plunger section 602. In embodiments of the invention where the interlock housing member 304b and the sliding insert member 301b are assembled prior to being affixed to a panel, coupling section 601 has periodically positioned access holes 607 for access to screw heads of screws used to affix affixing interlock body member 304b to sliding panel 106b when coupling section 0601 is assembled with interlock body member 304b. Ridges 606a and 606b are configured to hold a shock absorbing member for contacting the lip of an interlock on an adjacent sliding panel. Plunger section 602 contacts shock absorbing material at its distal end. Plunger section 602 is shown with optional ridges. Sliding insert member 301b can be fabricated using materials and techniques as discussed above, in connection with interlock housing member 304b.

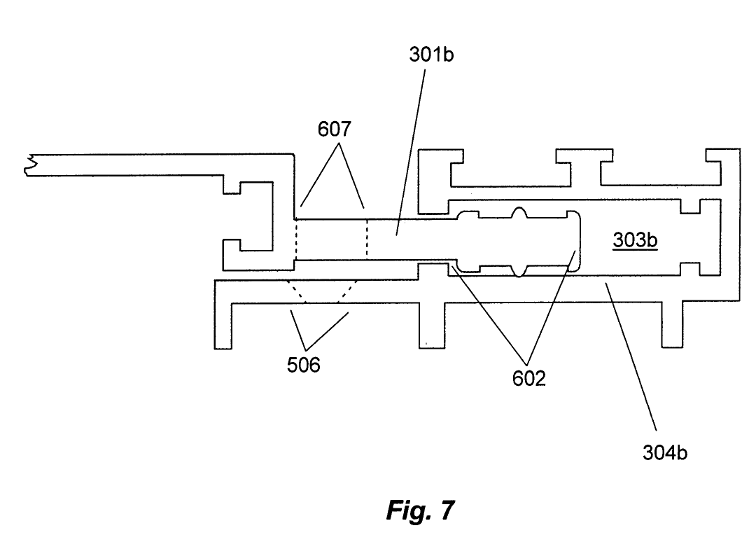

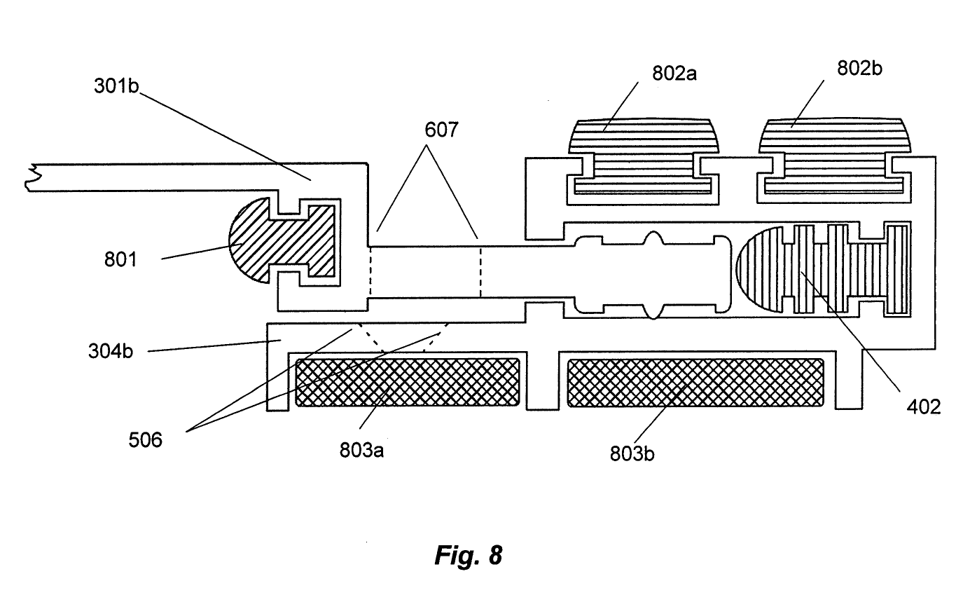

FIG. 7 illustrates a cross-sectional view of sliding insert member 301b assembled with interlock housing member 304b. As illustrated, the plunger section 602 of sliding insert member 301b can travel left and right within cavity 303b of interlock housing member 304. FIG. 8 illustrates a cross-sectional view of the interlock assembly of FIG. 7, with additional components according to an embodiment of the invention. External shock absorber insert 801 is configured to contact the lip of an interlock assembly on an adjacent sliding panel. External shock absorber 801 can be made of the same open, or closed cell foam, or elastomeric material as shock absorber 402, or of a different material with shock absorbing properties, including, for example, felt or the like. Inserts 802a and 802b can be friction bearing and/or shock absorbing gaskets that can promote a smooth gliding action between adjacent panels. They can, for example, be made of polyfluorocarbons such as Teflon®, a registered trademark of the Dupont Chemical Company, or foamed polyfluorocarbons. Gaskets 803a and 803b can fill the areas between the interlock housing member pedestals, to provide for further sound and/or vibration and shock dampening. These gaskets may be formed from elastomers, foamed, elastomers, felt, or the like. Mounting screw hole 506 is shown positioned under mounting screw access hole 607. A mounting screw can penetrate through gasket 803a for mounting an interlock on a sliding panel.

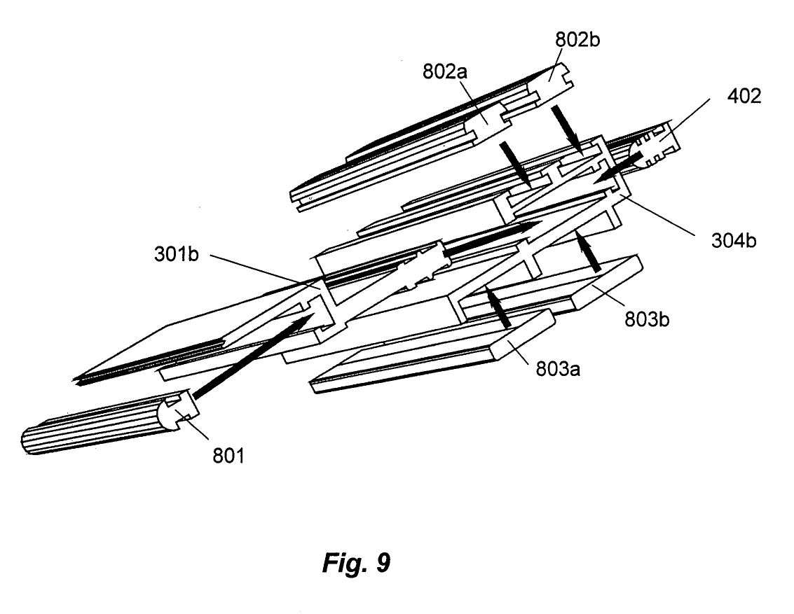

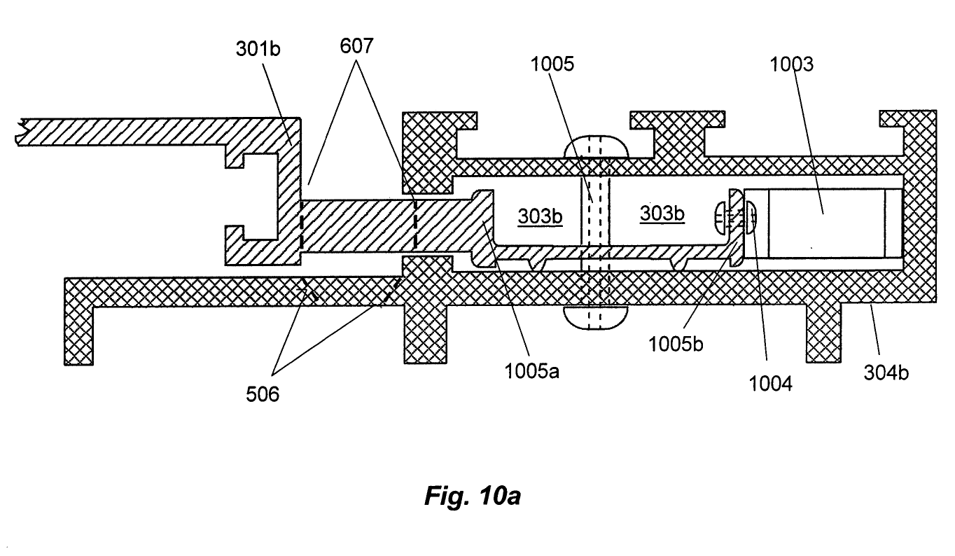

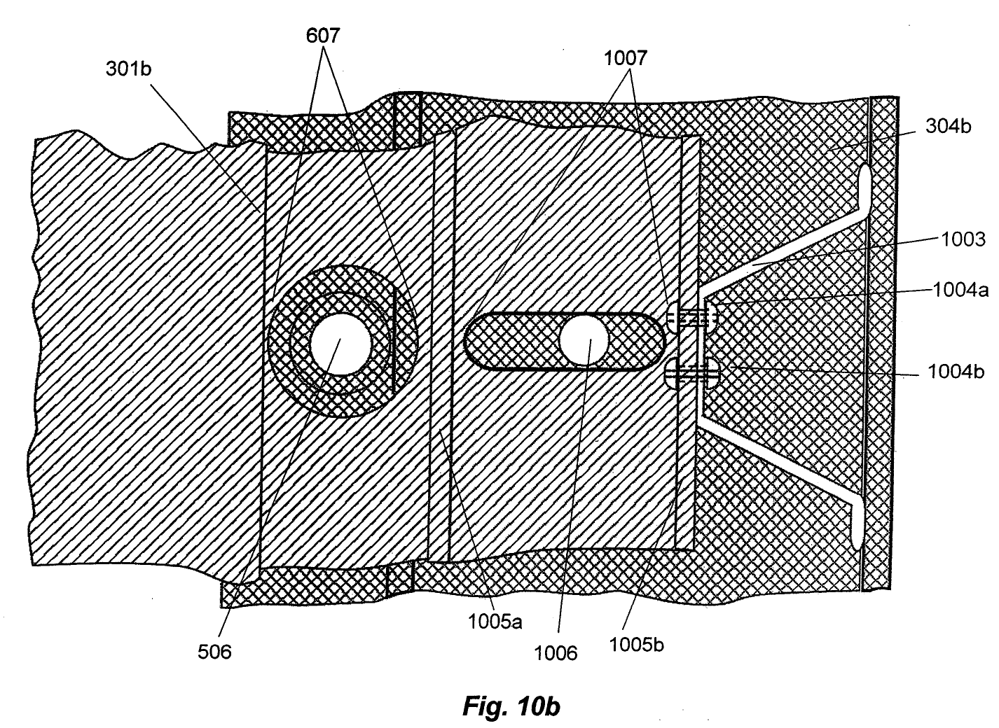

FIG. 9 illustrates an exploded, perspective view of the embodiment of FIG. 8. In some embodiments interlock housing member 304b can be closed at one or both ends to prevent the sliding insert member 301b from sliding out of interlock housing member 304b in a direction substantially orthogonal to sliding insert member 301b's motion during interlock operation.

FIG. 10a illustrates a cross-sectional view of another embodiment of the invention, whereas FIG. 10b shows a top view of the same embodiment, with the top cover of interlock housing member 304b removed for purposes of illustration. In this embodiment, a leaf spring 1003 functions as an internal shock absorber, and is affixed to sliding member 301b by rivets 1004a and 1004b. Alternatively, the rivets may be replaced by nut and bolt assemblies, or the leaf spring may be affixed to sliding member 301b using a variety of other techniques such as welding, soldering, adhesives, clips, and so forth, as are well known to one of ordinary skill in the art.

Referring to FIG. 10b, slot 1007 allows horizontal movement of sliding insert member 301b about a post inserted through hole 1006 in interlock housing member 304b, while limiting the vertical movement of sliding insert member 301. The mounting screw access hole 607 of sliding insert member 301 is shown positioned over the mounting screw hole 506 of interlock housing member 304b. Referring again to FIG. 10a, post 1005 is shown positioned through the top and bottom surfaces of interlock housing member 304b, passing through slot 1007 of the sliding insert member as shown in FIG. 10b. Post 1005 may be a rivet, a bolt and nut assembly, or a post affixed within interlock housing member 304b, at its first and/or second ends using a variety of techniques, such as welding, soldering, adhesives, press-fit, and so forth as are well known to one of ordinary skill in the art. In alternative embodiments, the housing member 304b is simply closed at its bottom end to prevent the sliding insert member 301b from sliding vertically downward during operation.

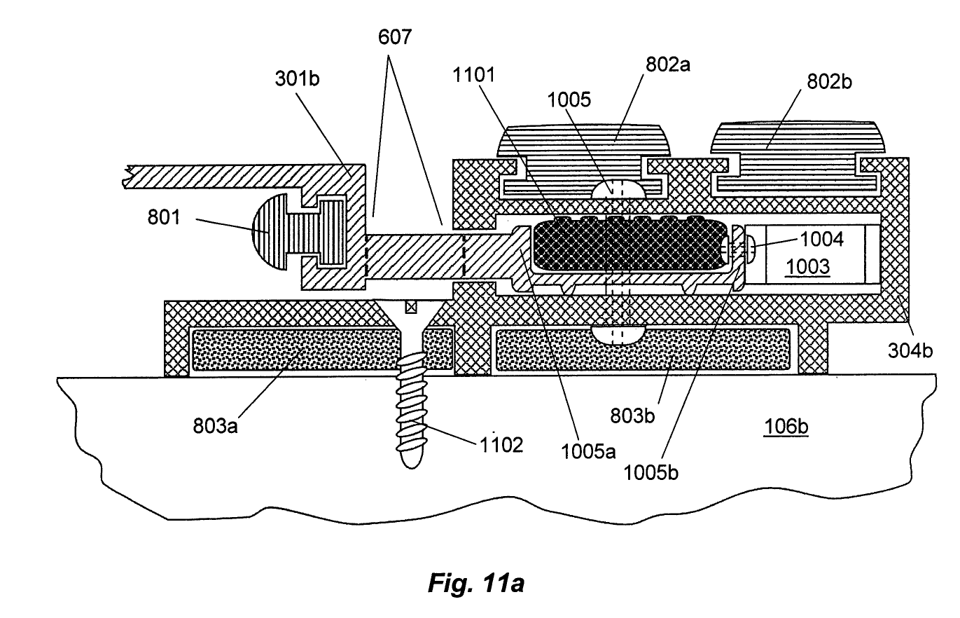

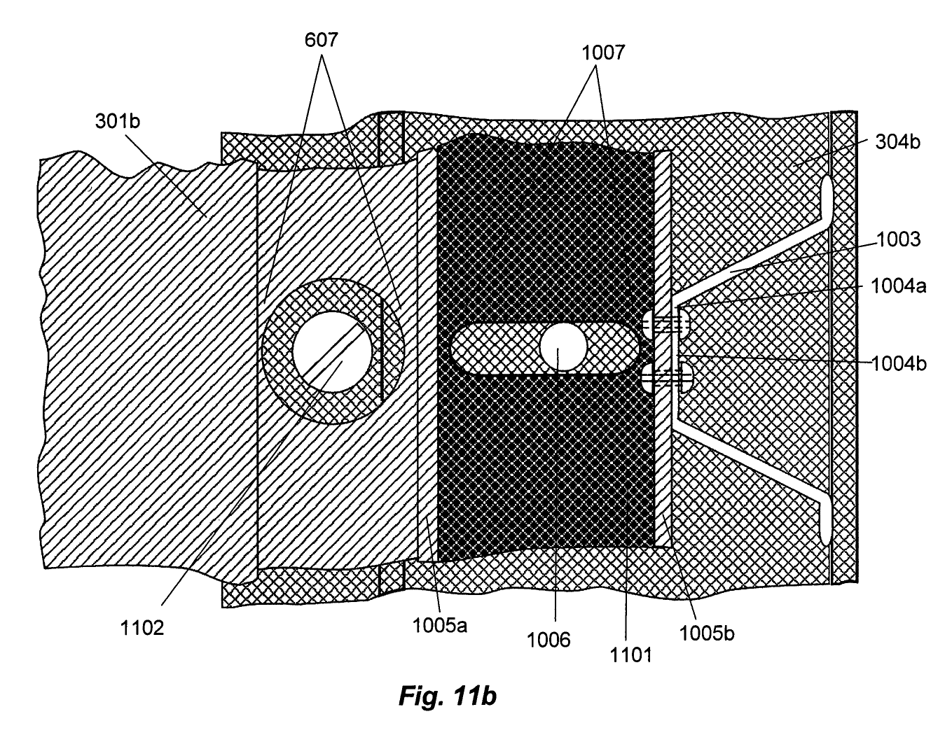

FIG. 11 a is a cross-sectional drawing illustrating the embodiment of FIG. 10a, with additional components, and installed on a sliding panel 106b. Gaskets 802a and 802b are friction bearing and shock absorbing members as described in connection with the above embodiments. Shock absorbing member 801, is configured to contact the engagement lip of an interlock assembly on an adjacent sliding panel, as described above in connection with the other embodiments. Gaskets 803a and 803b are likewise as described above in connection with the other embodiments. Dampening insert 1101 is affixed to sliding insert member 301b and is configured to dampen the horizontal motion of sliding insert member 802, through friction with an adjacent inside surface of interlock housing member 801. Dampening insert 1101 can be made of elastomeric material, or open or closed cell foams, as described above in connection with the internal shock absorber. In some embodiments dampening insert 1101 has a ribbed surface for contacting the adjacent inside surface of interlock housing member 304b, to further enhance frictional damping. Dampening insert 1101 can be affixed to sliding insert member 301b by adhesives, or similar means, or it may be simply held in place by walls 1005a and 1005b of sliding insert 301b. Dampening insert 1101 can suppress a tendency of the interlocks to bounce when first engaged. Screw 1102 is shown installed through its hole in interlock housing member 304b, through gasket 803a, and driven into sliding panel 106b. FIG. 11b is a top view of the embodiment of FIG. 11a, with the top cover of interlock housing member 304b removed for purposes of illustration. Dampening insert 1101 has a slot 1107 formed therein to allow sliding motion of the sliding insert. Slot 1107 can also constrain the vertical motion of dampening insert 1101 that is normal to the sliding motion during operation.

Although the embodiments of FIGS. 11a and 11b have been illustrated with a leaf spring 1003, a plurality of leaf springs may be used along the vertical length of sliding insert member 304. Also, the leaf spring may be replaced with the other types of shock absorbers as described in connection with FIGS. 4a, 4b, and 4c.

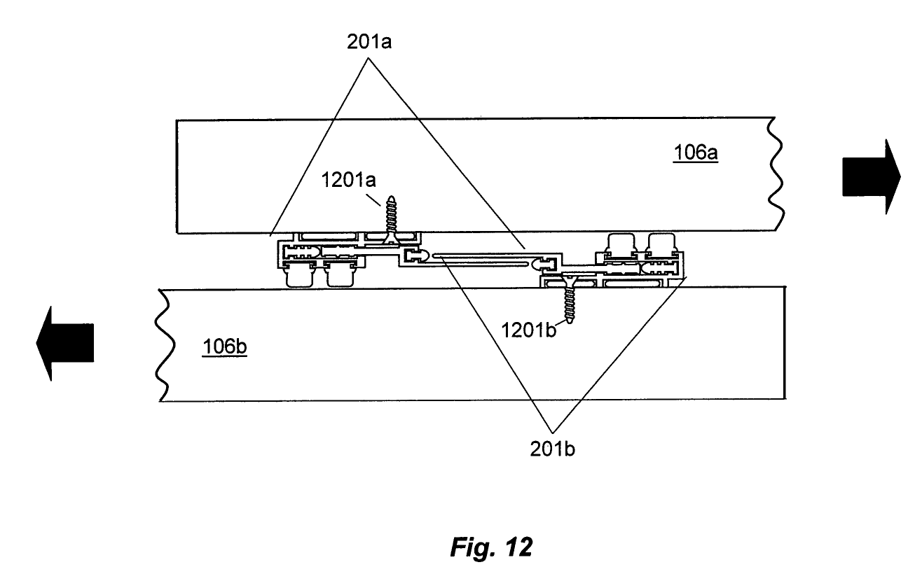

FIG. 12 illustrates an operation of an embodiment of the invention, wherein sliding panel 106a slides along and interlocks with sliding panel 106b, as illustrated by the arrows. Interlock assembly 201a is mounted to sliding panel 106a using one or more screws 1201a. Interlock assembly 201b is mounted to sliding panel 106b using one or more screws 1201b. As the interlock engages, the lip of interlock assembly 201a contacts the lip contact external shock absorber 801 in (FIG. 8) of interlock assembly 201b, and the lip of interlock assembly 0201b contact the lip contact external shock absorber of interlock assembly 201a. Additional contact shock is absorbed by the internal shock absorbers of interlock assemblies 201a and 201b, as the force is coupled through their respective sliding insert members.

Variations and extensions of the embodiments described are apparent to one of ordinary skill in the art. Other applications, features, and advantages of this invention will be apparent to one of ordinary skill in the art who studies this invention specification. Therefore, the scope of this invention is to be limited only by the following claims.

1. A shock absorbing interlock assembly for sliding panels comprising:
a first sliding insert member having a first engagement lip configured to engage with a second engagement lip of a second sliding insert member of a second shock absorbing interlock assembly;
a housing member, configured to be mounted to a sliding panel, the housing member including a channel configured to slidably hold a section of the first sliding insert member therein;
a first shock absorbing member, disposed within the channel of the housing member and configured to contact and absorb energy transferred from the first sliding insert member.

2. The interlock assembly of claim 1, wherein the interlock assembly housing member further comprises a screw hole for mounting the assembly to a sliding panel.

3. The interlock assembly of claim 2, wherein the first sliding insert member further comprises a mounting screw access hole.

4. The interlock assembly of claim 1, wherein the first shock absorbing member comprises at least one of a helical spring, a leaf spring, an open-cell foam, a closed-cell foam, and an elastomer.

5. The interlock assembly of claim 1, further comprising a second shock absorbing member coupled to the first sliding insert member, and configured to contact and absorb energy transferred from the second engagement lip of the second sliding insert member.

6. The interlock assembly of claim 5, wherein the second shock absorbing member comprises at least one of an open-cell foam, a closed-cell foam, and an elastomer.

7. The interlock assembly of claim 1, further comprising at least one friction bearing, shock absorbing gasket, coupled to a top surface of the housing member, wherein the gasket is configured to contact an adjacent sliding panel.

8. The interlock assembly of claim 1, further comprising at least one gasket disposed between the housing member and the sliding panel to which the housing member is affixed.

9. The interlock assembly of claim 1, further comprising a dampening insert, coupled to the sliding insert member, and configured to dampen the horizontal motion of the sliding insert member through friction with an adjacent inside surface of the interlock assembly housing member.

10. The interlock assembly of claim 1, wherein the sliding insert member has a slot configured around a post that is affixed to the interlock assembly housing member to limit vertical motion of the first sliding insert member while allowing horizontal sliding motion of the first sliding insert member during interlocking operation.

11. A shock absorbing interlock assembly for sliding panels comprising:
engagement means, coupled to a first sliding panel, for engaging a second sliding panel when the first sliding panel is in motion; and
means for absorbing energy imparted from the first sliding panel to the second sliding panel when the first sliding panel engages with the second sliding panel.

12. The interlock assembly of claim 11, further comprising means for dampening a horizontal sliding motion of a horizontally slidable member of the interlock assembly.

13. The interlock assembly of claim 11, further comprising at least one friction bearing gasket for promoting smooth gliding action between the first and second sliding panels.
